(19) United States
(12) Patent Application Publication
(10) Pub. No.: US 2008/0215418 A1
(43) Pub. Date: Sep. 4, 2008

(54) MODIFICATION OF ADVERTISEMENT CAMPAIGN ELEMENTS BASED ON HEURISTICS AND REAL TIME FEEDBACK

(75) Inventors: Eric Andrew Kolve, Seattle, WA (US); David Michael Sliwa, Seattle, WA (US); Aaron Hungate Finn, Seattle, WA (US); Derek Alan Streat, Seattle, WA (US)

Correspondence Address: DARBY & DARBY P.C., P.O. BOX 770, Church Street Station, New York, NY, 10008-0770, US

(73) Assignee: AdReady, Inc., Seattle, WA (US)

(21) Appl. No.: 12/040,584

(22) Filed: Feb. 29, 2008

Related U.S. Application Data
(60) Provisional application No. 60/892,799, filed on Mar. 2, 2007.

(51) Int. Cl. G06Q 30/00; G06Q 10/00

(52) U.S. Cl. 705/10

(57) ABSTRACT

Enabling the selection, modification, and subsequent generation of online advertisements for either a one time use or as part of an advertising campaign. The performance of an advertisement is iteratively reviewed based on heuristics, statistics, metrics, real-time feedback, and the like, either singly or in some combination. Iterative monitoring of performance information for related, but different, online advertisements is analyzed and employed to recommend and/or automatically generate changes to an online advertisement, or advertising campaign. An editing facility is also provided to enable a user to modify a plurality of elements in an online advertisement, and at least some of these editable/modifiable elements are monitored for performance information. The editing facility can enable editing of different file formats for online advertisements, including, Flash, SVG, and Gnash.

### CROSS-REFERENCE TO RELATED APPLICATIONS

The present application claims priority from provisional application Ser. No. 60/892,799 entitled “Modification of Advertisement Campaign Elements Based on Heuristics and Realtime Feedback,” filed on Mar. 2, 2007, the benefit of the earlier filing date of which is hereby claimed under 35 U.S.C. § 119 (e) and 37 C.F.R. §1.78, and which is further incorporated herein by reference.

### TECHNICAL FIELD

The present invention generally relates to advertising over a network, and in particular, but not exclusively to the selection, modification, and generation of online advertisements based on heuristics, statistics, metrics, and other information.

### BACKGROUND

Advertising and Internet advertising are fast-paced multi-billion dollar industries. In the advertising industry, the advantages of presenting attractive, attention-getting, and memorable advertisements are well recognized. Such advertisements can increase brand recognition, improve sales, and can be an integral part of a public relations campaign.

Traditionally, advertisers refine and optimize advertising campaigns by using focus groups, consumer polling, advertising consultants, and/or the like. These mechanisms may be used to review consumer response and acceptance of advertisements but can be both time consuming and labor intensive. Such disadvantages increase cost and lengthen the time required to roll out desirable changes.

The advent of the Internet and other networks presents other types of media enabling communications with consumers and/or the public. These networks provide a unique mechanism for presenting advertisements to targeted segments of the population through an almost infinite array of advertising publishers. These publishers include traditional content providers as well as non-traditional organizations and individuals. Also, each targeted population segment is likely to have different preferences and thus a different response to any particular advertisement. The large number of online publishers coupled with the potential to target multiple population segments makes it increasingly difficult and expensive to optimize an advertising campaign.

### BRIEF DESCRIPTION OF THE DRAWINGS

FIG. 1 is a screenshot depicting one embodiment of a collection of advertisements which may be organized into a library;

FIG. 2 is a screenshot depicting one embodiment of descriptive information regarding a selected advertisement from an advertisement library;

FIG. 3 is a screenshot depicting one embodiment of configuration information regarding an advertisement;

FIG. 4 is a screenshot depicting one embodiment of advertisement content information regarding an advertisement;

FIG. 5 is a screenshot showing one embodiment of certain performance elements for a number of advertisements;

FIG. 6 is a block diagram illustrating an environment for practicing the invention;

FIG. 7 illustrates one embodiment of a server device for practicing the invention;

FIG. 8 illustrates one embodiment of a mobile device that may be included in a system implementing the invention;

FIG. 9 is a workflow diagram depicting one embodiment of an advertising workflow; and

FIG. 10 is another workflow diagram illustrating one embodiment of an advertising workflow.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may.

The terms “efficiency” or “efficient” as used herein, refer to the number of consumer interactions with a particular online advertisement that is published either singly, or as part of a campaign, e.g., web page impressions, browse-overs, click-throughs and the like.

The terms “performance,” “performing,” and “perform,” as used herein, refer to effective consumer interactions with an online advertisement, e.g., impressions, clicks, a sale of a product or service, completion of a questionnaire and/or virtually any other form, survey, or the like by a viewer of the advertisement, providing customer profile information, completion of a customer login, and/or the like, or even receiving feedback indicating that a viewer of the online advertisement visited a merchant associated with the online advertisement.

Briefly stated, the invention generally relates to enabling the selection, modification, and generation of online advertisements for publication either singly or as part of an advertising campaign on networked computing devices, e.g., personal computers, laptop computers, mobile devices, cellular telephones, personal digital assistants, video game consoles, or the like. An editing facility is provided that enables a user to create or modify elements in online advertisements, which can be provided by the user, or third parties. These modifiable elements include text, background color, foreground color, size, font size, font type, publisher bid, publisher identity, page placement, bitmaps, vector images, graphics, icons, movies, videos, audio, animation, logo, template, targeted demographic, and/or the like, and combinations thereof. Also, heuristics, statistics, metrics, and other information can be collected and subsequently employed to statically and/or dynamically analyze and monitor the performance and efficiency of modifiable elements in an online advertisement, and the advertisement itself. The invention also compares the performance and efficiency of element modifications to one or more elements in other online advertisements.

Online advertisement campaigns can include one or more methods for publishing the advertisements, including search engine advertising, desktop advertising, online advertising directories, advertising networks, message (email, IM, SMS, MMS) advertising, and the like. Also, the advertisements themselves, can be published in different ways, including, but not limited to, text only ads, banner ads, popup ads, pop-under ads, interstitial ads, floating ads, expanding ads, wallpaper ads, video ads, audio ads, animated ads, trick banner ads, map ads, and/or the like.

A modification to one or more elements of an online advertisement can be initiated by the advertiser/user or suggested by the invention based on analysis and monitoring of the performance and efficiency of online advertisements controlled by the user and/or other online advertisements controlled by other users. In at least one embodiment, the performance and efficiency is determined for at least one or more elements in other online advertisements controlled by the user and/or other users. The higher performing and/or efficient elements in the other online advertisements can be aggregated and grouped into categories, types, industries, and the like. In at least one embodiment, one or more elements that are determined to improve performance and/or efficiency can be employed at least in part as the basis for suggestions for modifications/additions to elements in online advertisements controlled by the user, or by various components of the system, Advertising Service Provider (ASP), an advertiser, a third party vendor, and/or the like As related to the field of advertising, the nature of networks provides an opportunity for a user to easily publish an advertisement to a relatively large audience with one or more content publishers. Commonly, content publishers charge advertisers fees based on trackable interactivity such as the number of unique views by a potential customer (pay-per-impression), and the number of click-throughs (pay-per-click) on the advertiser's advertisement. Sometimes publishers charge fees based on a combination of the number of impressions and the number of click-throughs, or the number of resulting interactions.

Online advertising publishers such as Google, Yahoo, Advertising.com, and/or the like, typically employ automated systems for uploading online advertisements and setting configuration options such as the target market, campaign length, advertising budget, or maximum bid. These systems often allow the advertiser to setup and run their advertising campaign themselves, without direct assistance from the publisher. Also, there is often little or no charge for uploading and configuring an online advertisement or multiple online advertisements.

The online advertising framework enables advertisers to quickly gather statistics and other metrics relating to the performance of advertisements. In addition, the nature of online advertising allows advertisers to more easily determine which advertisements or group of advertisements generate the highest level of consumer interest, consumer activity, and/or the like. For example, content publishers often enable advertisers to check the number of impressions, verify the number of click-throughs, determine the effective cost per thousand impressions (CPM), and/or the like. Advertisers can often track click-throughs to further determine if it resulted in further customer interaction, e.g., a sale, sign-up, and/or the like.

By coupling the ability to setup and run multiple online advertisements with the ability to track individual statistics and other metrics for each running advertisement, advertisers Advertising Service Provider (ASP), various components of the invention, a third party vendor, and/or the like can determine whether a given advertisement is performing well or is underperforming relative to other advertisements. These determinations may also be used to rate the efficiency and performance of multiple advertisements. Advertisers Advertising Service Provider (ASP), a third party vendor, various components of the system, and/or the like can use this information to reallocate advertising resources, adjust configuration options, analyze the advertisement elements, optimize the performance and effectiveness of the advertisements, and/or combinations thereof.

In one embodiment, the invention provides for a server-side web-based application which automatically manages advertising resources based on various information, including heuristics, statistics, metrics, efficiency, performance, and other information for an online advertising campaign, such as those conducted over a network, which can include the Internet. Performance information may be collected that includes, but is not limited to, a number of click-throughs, a ratio of click-throughs to impressions, the effective CPM, a number or ratio of customer interactions, e.g., sales, sign-ups, and/or the like. Performance information can be retrieved from different sources, including a content publisher, tracking interactivity on the advertiser's web servers, and/or the like. Also, the management of advertising resources may be manually or automatically carried out by an Advertising Service Provider (ASP), the advertiser, a third party vendor, and/or the like.

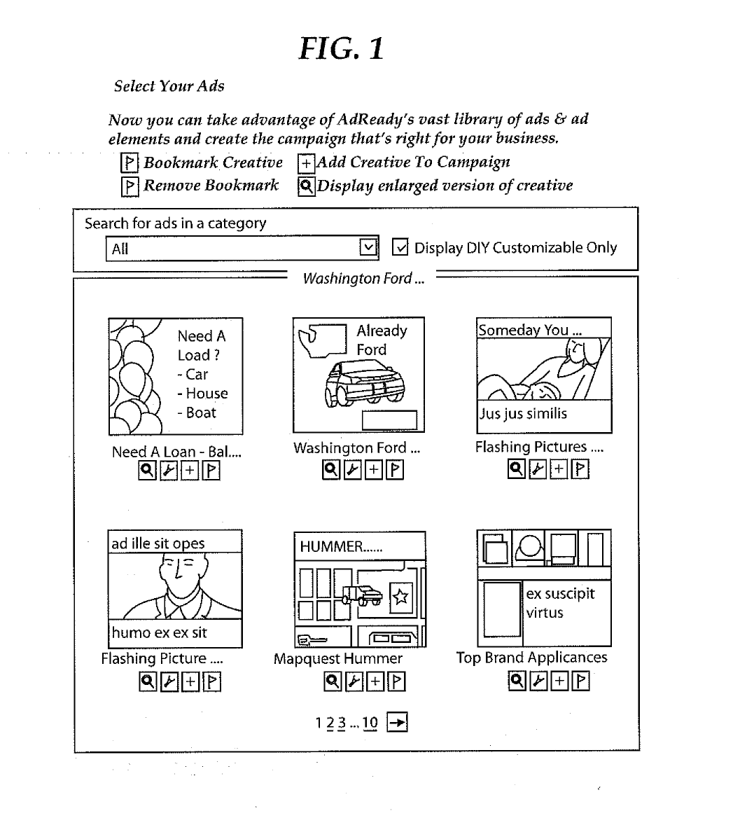

FIG. 1 is a screenshot depicting one embodiment of a collection of advertisements which may be organized into a library. It should be noted that the illustrated advertisements as shown are merely examples, and not intended to limit or otherwise constrain the invention.

The library may include advertisements provided by the ASP, recommended by the ASP, or advertisements uploaded by the advertiser or a third party. The advertisements may be in varying states of completion. For example, an advertisement may be complete and ready to publish, a skeleton representing a general idea or theme, a template substantially ready to publish, a recommendation awaiting approval, and/or the like. Advertisers are enabled to use the library to manage all or some of their advertising assets. From the library, an advertiser can review the advertisements and can either start an advertising campaign with selected advertisements or bookmark selected advertisements for later review and/or publication or insert advertisements into existing advertising campaigns. An advertiser may also select and/or customize a selected online advertisement prior to starting an advertising campaign.

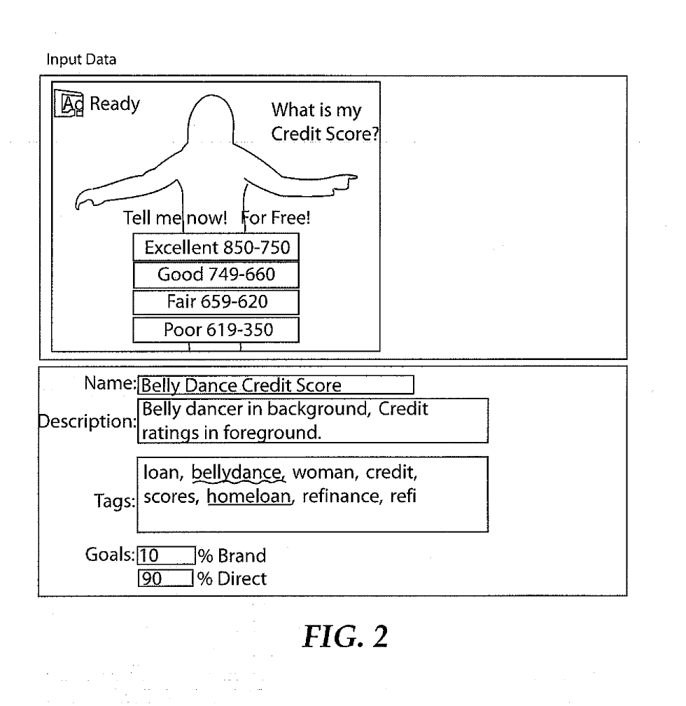

FIG. 2 is a screenshot depicting one embodiment of descriptive information regarding a selected advertisement from an advertisement library. In one embodiment, the ASP may provide tagging and commentary capability for one or more advertisements. Such capability could allow advertisers to tag certain advertisements and store comments or descriptions of each advertisement. The depicted implementation of tagging and commentary capabilities shown in FIG. 2 provides one possible mechanism for an advertiser to organize and arrange their advertising assets.

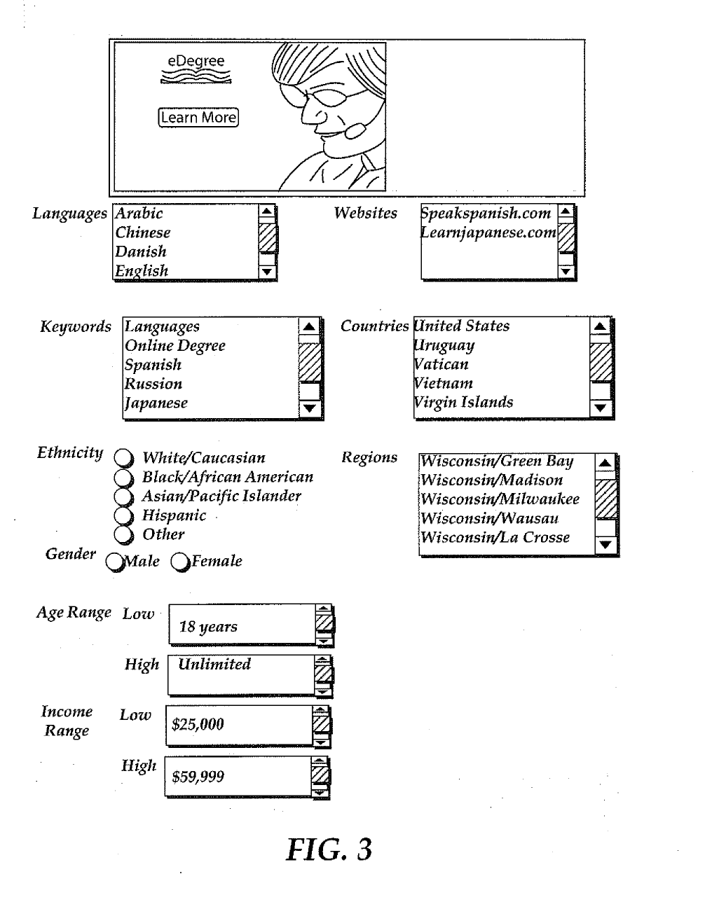

FIG. 3 is a screenshot depicting one embodiment of configuration information regarding an advertisement. In one embodiment, the ASP may provide a mechanism which enables an advertiser to target certain demographics. For example, the ASP may collect attributes from the advertiser regarding a targeted demographic including the targeted income bracket, geographic area, age, gender, industry, ethnicity, language ability, and/or the like. The ASP may also collect attributes such as the languages in which to run advertisements, selected publishers, selected keywords with which to link the advertisement, and/or the like. Further, the ASP may also collect online advertiser preferences regarding the use of promotions, other offers, and/or the like.

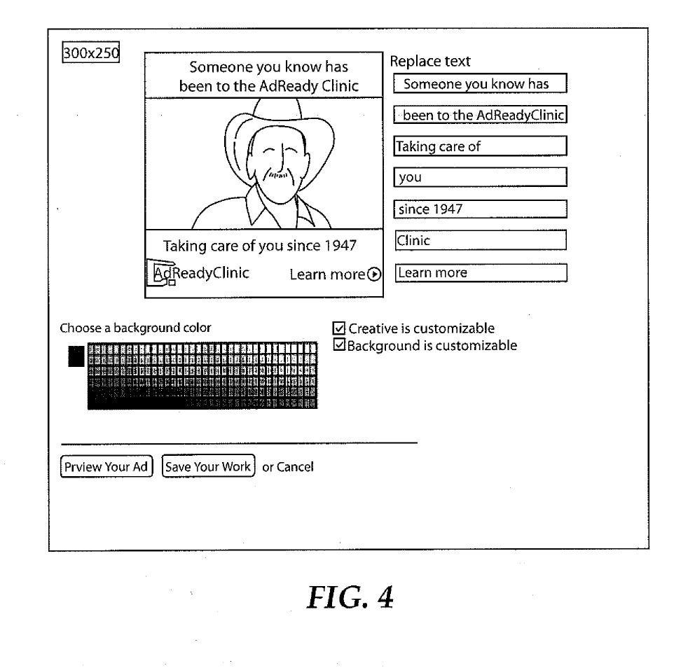

FIG. 4 is a screenshot depicting one embodiment of advertisement content information regarding an advertisement. As discussed above, the ASP may provide template advertisements that can be customized for use by an advertiser. Additionally, an ASP may also provide an advertisement modification utility for easing customization, modification, and generation of advertisements, including template advertisements. As can be seen in FIG. 4, a selected advertisement may be customized with an advertiser's name, colors, text, and/or other similar elements. Further, additional elements such as the advertiser's logo, images, sub-images, fonts, size, and/or the like could also be customized in template advertisements, or by using the advertisement modification utility. Likewise, an advertisement modification application may include the capability to preview a modified advertisement.

At least one embodiment of the advertisement modification application enables modification, customization, and generation of online advertisements that are provided in the Flash file format (identifiable by the .swf file extension) and editable with an application programming interface (API). Also, one or more embodiments enable modifying, customizing and generating other types of files that may support one or more APIs. For example, the Free Software Foundation's Gnash file format, the W3C's Scalable Vector Graphics file format, ActionScript script files, and the like, can be employed with at least one embodiment of the invention. However, the advertisement modification utility is not limited to these formats. Other embodiments enable modifying, customizing and generating any other file format that can be employed for online advertisements.

Such online advertisements can, for example, be suitably displayed using an application such as a Flash Player, and/or a client viewer plug-in for another application such as a browser. Media such as online advertisements using the Flash format are identifiable by the swf file extension. The .swf file format is a binary file format capable of storing elements such as text, font type, font size, foreground color, background colors, certain animated modules, bitmaps, vector images, other graphics, or images, audio, and/or the like, for playing on a computing device. The designer and/or programmer employ one or more tools, APIs, and the like, to generate a source file for an online advertisement. This source file (.fla file extension) is subsequently compiled into a binary file (.swf file extension) that can be distributed for playback with a Flash player or client viewer plug-in application.

When an online advertisement is created by a third party, a user may not have ready access to the source file, thus increasing the difficulty of modifying or customizing the online advertisement. In at least one embodiment of the invention, an advertisement modification utility is provided to modify the binary file, such as a .swf file, to change elements of an advertisement. For example, such a utility can enable reading, adding, removing, modifying, resizing, replacing, and/or the like, elements which are placed “on the stage”, i.e., to be viewable/interacted with in an online advertisement Examples of modifiable elements that can be tracked and analyzed include text, images, element placement, text color, background color, foreground color, size, font size, font type, publisher bid, publisher identity, page placement, bitmaps, vector images, graphics, icons, movies, videos, audio, animation, logo, template, targeted demographic, and/or the like, and combinations thereof.

Additionally, certain implementations of the advertisement modification application includes the capability to “import” a binary file for an advertisement, determine which elements can be modified and/or customized, and enable a user to make such modifications and customizations. Such capability enables customization of template advertisements, advertiser uploaded advertisements, third party advertisements, and/or the like. Certain implementations of the advertisement modification application are also capable of generating new online advertisements, based in part, on other online advertisements provided and/or controlled by others.

In certain embodiments, an interface such as the one shown in FIG. 4 may be used to control or otherwise interact with an advertisement modification application. As illustrated, the application has extracted text and color elements from the advertisement and placed the extracted elements into editable fields. Likewise, the advertisement modification application may include the capability to modify additional elements, such as the elements discussed above. Moreover, the advertisement modification application may be capable of modifying template advertisements, advertiser uploaded advertisements, third party Flash advertisements, and/or the like.

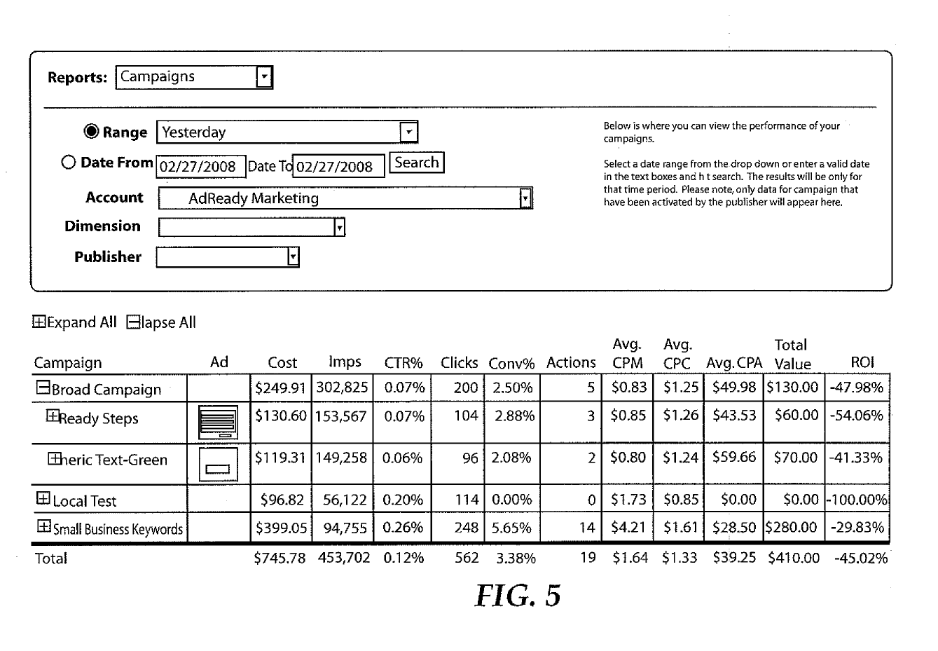

FIG. 5 is a screenshot illustrating certain performance statistics and other metrics for a number of advertisements. This screenshot shows statistics and other metrics such as the number of impressions, the click-through percentage, the number of click-throughs, the conversion rate between click-throughs and further customer interactions, and the costs associates with these metrics for each advertisement. As discussed above, these statistics and metrics can be retrieved from an online advertising publisher, determined by tracking activity on the advertiser's web servers, and/or the like. These statistics and metrics, and suitable combinations thereof, can also be used to provide real-time feedback relating to the performance of the advertisements.

In some embodiments, an ASP performance optimization application is enabled to publish multiple advertisements with online advertising publishers. These multiple advertisements may have substantial differences, or may merely have minor differences such as different text, font, or color. Further the performance optimization application may also be configured to automatically retrieve and monitor performance statistics, heuristics, and metrics from the online advertising publishers and determine which of the multiple advertisements are performing better than other advertisements. As discussed above, this determination can be made based, wholly or in part, on the number of click-throughs, the ratio of click-throughs to impressions, the number or ratio of customer interaction, sales, sign-ups, return on investment, and/or the like. In at least one embodiment, the performance optimization application may also iteratively determine and/or retrieve statistics, heuristics, and other metrics from the advertisers, and/or third parties and use this information, either singly or in combination, or in conjunction with yet more information provided by one or more online advertising publishers, to further refine the comparison of the performance of online advertisements. Likewise, the performance optimization application may rely on data related to a particular advertising campaign or advertiser, or may share performance data across multiple campaigns or advertisers.

From these statistics, heuristics, metrics, and other information the ASP performance optimization application can analyze the performance of each advertisement relative to the other advertisements. This application may also analyze the multiple advertisements to determine differences between the advertisements, if such differences are not already tracked by the application. By determining or tracking the differences, the performance optimization application can analyze which elements of the online advertisement are related to performance, consumer interest, consumer interaction, and/or the like. Examples of modifiable elements that can be tracked and analyzed include advertisement text, images, element placement, text color, background color, foreground color, size, fonts, publisher bid, publisher identity, page placement, animation, audio, logo, template, targeted demographic, and/or the like, and combinations thereof.

Further, the performance optimization application may be enabled to modify advertisements to incorporate positive performing elements, notify the advertiser, recommend actions that the advertiser/user can take to improve advertising performance, efficiency, and/or the like. In at least one embodiment, modification, generation, and subsequent publishing of online advertisements may be performed automatically, without human intervention. However, the performance optimization application could also be suitably configured to generate and present recommended online advertisements for review by the user/advertiser prior to publishing. For example, the performance optimization application may present certain recommended advertisements, advertising themes, advertising bids, advertising budgets, publishers, and/or the like, to an advertiser upon the advertiser's login to the system. The advertiser could then accept and publish the recommended advertisements either singly, or as part of an advertising campaign. Further, the performance optimization application may be configured to automatically publish modified advertisements or make other changes if a user has not rejected, approved, viewed, not viewed, and/or the like, the modified advertisements during a delay or waiting period.

In certain embodiments, it may be beneficial to analyze multiple variables, as discussed above, such as font size foreground color or background color, and/or the like. In certain instances, statistical analysis may indicate that certain combinations of elements are predicted to yield desirable results. However, for various reasons, these combinations may produce an advertisement that is visually incoherent or otherwise not useful for publication. For example, a text color may be selected that does not provide sufficient contrast with a background color.

Accordingly, the performance optimization application may be configured to use additional techniques to determine whether certain combinations of elements do not perform well. For example, certain applications may use Bayesian filtering techniques, multi-variant testing, A/B testing, design of experiments (DOE) approaches, and/or the like. Use of these techniques could also be used in conjunction with the automatic modification and publication of advertisements, as discussed above. Additionally, the performance tracking application may be configured to provide analysis, recommendations, modifications, and/or the like, only after statistically valid data has been collected. The threshold for such validity may be suitably configured for each individual advertiser or advertising campaign.

After the modified advertising campaign or advertisements have been published, the performance optimization application may be enabled to retrieve and monitor performance statistics and acquire feedback on the modified advertisements. By utilizing such feedback and carrying out iterative performance tracking and modification, an advertising campaign can be further modified. The performance optimization application may be configured to continue in an iterative loop, until certain performance goals are met, for a set number of iterations, and/or the like, as suitable for a given situation. For example, in one embodiment, the iteration of modifying the online advertisement might occur until a defined value is exceeded for an overall effectiveness and/or performance of the modified online advertisement.

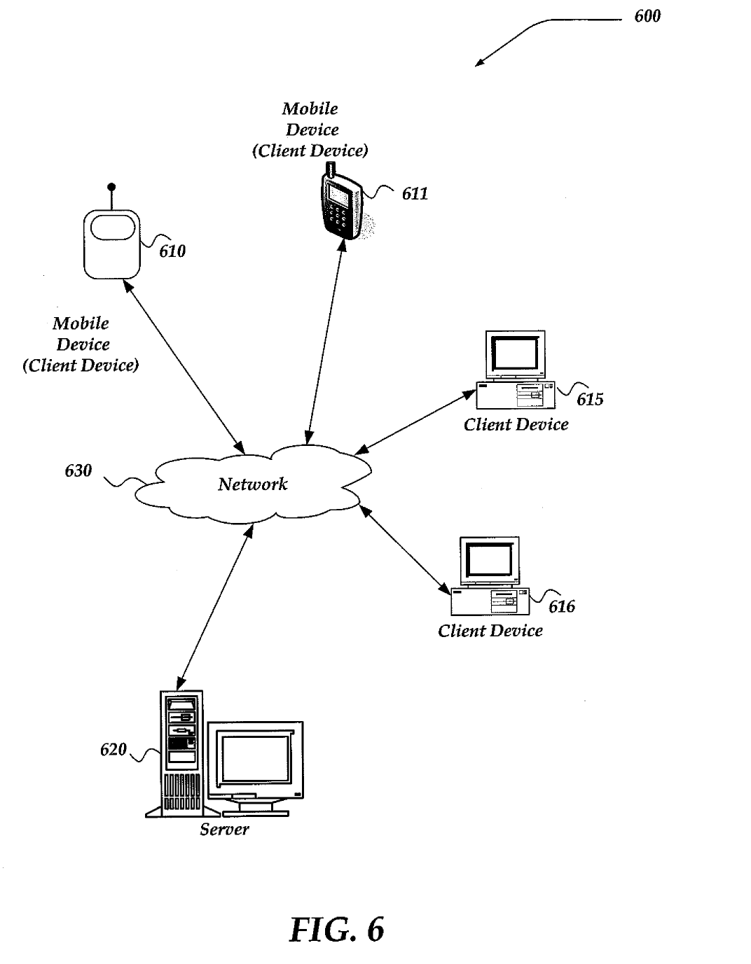

FIG. 6 illustrates one embodiment of an environment in which the invention may operate. However, not all of these components may be required to practice the invention, and variations in the arrangement and type of the components may be made without departing from the spirit or scope of the invention.

As shown in FIG. 6, system 600 includes first and second mobile devices 510-511, first and second client devices 515-516, server 520, and network 530.

Generally, first and second mobile devices 611-612 and first and second client devices 615-616 and server 620 may include virtually any computing device capable of connecting to another computing device to send and receive information, including web requests for information from a server device, and the like. First and second mobile devices 611-612 and first and second client devices 615-616 may further include a client application that is configured to manage various actions, for example, a web browser application that is configured to enable an end-user to interact with server 620 other devices and applications over network 630.

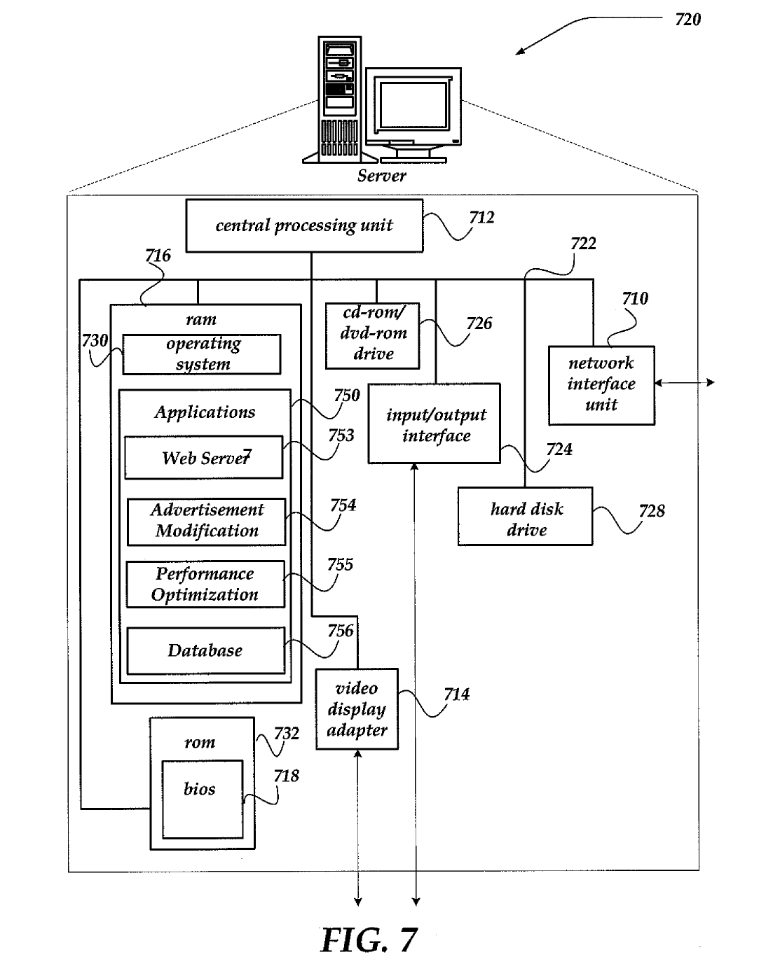

Likewise, server 620 may include a server application that is configured to manage various actions, for example, a web-server application that is configured to enable an end-user to interact with server 620 over network 630. In one embodiment, server 620 may be configured to manage advertising resources based, in part, on heuristics and/or performance statistics and other metrics. FIG. 7 shows one embodiment of a server, according to one embodiment of the invention. Server 720 may include many more or less components than those shown. The components shown, however, are sufficient to disclose an illustrative embodiment for practicing one or more embodiments of the invention.

Server 720 includes processing unit 712, video display adapter 714, and a mass memory, all in communication with each other via bus 722. The mass memory generally includes RAM 716, ROM 732, and one or more permanent mass storage devices, such as hard disk drive 728, tape drive, optical drive, and/or floppy disk drive. The mass memory stores operating system 730 for controlling the operation of server 720. Server 720 also includes applications 750, including for example, web-server 753, advertisement modification application 754, and performance optimization application 755, which may be expressed as one or more executable instructions stored at one or more locations within RAM 716, although the instructions could be stored elsewhere. Server 720 may also include database 756 or other archive or medium for storing, retrieving, organizing, and otherwise managing advertisements, advertising campaigns, and elements thereof.

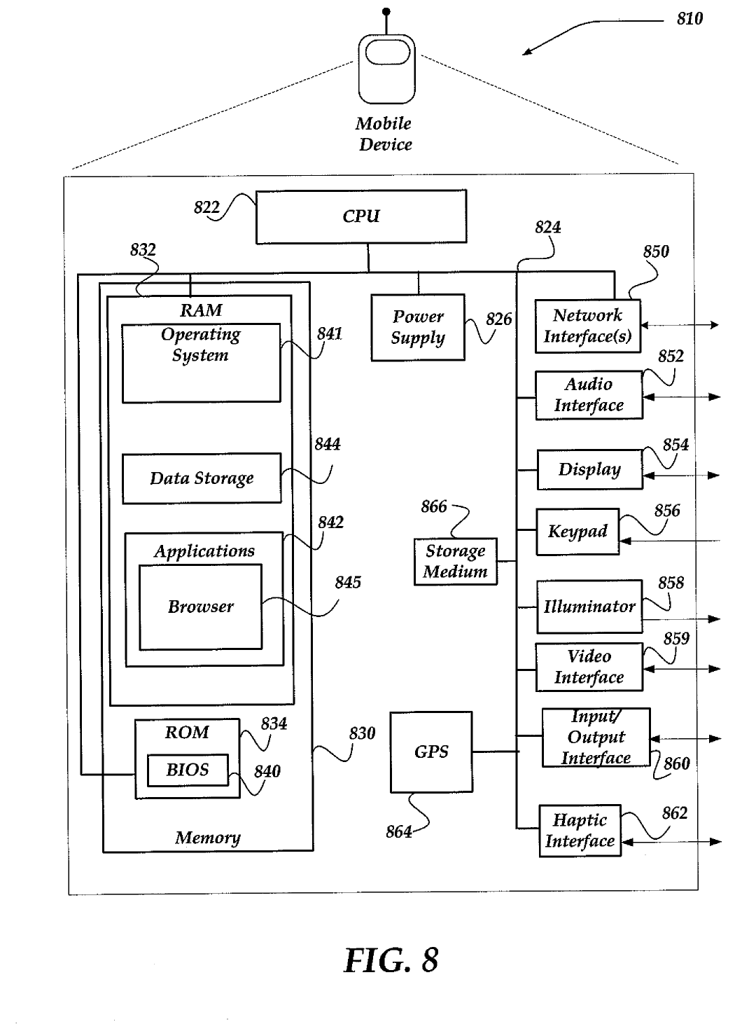

FIG. 8 shows one embodiment of mobile device 810 that may be included in a system implementing the invention. Mobile device 810 may include many more or less components than those shown in FIG. 8. However, the components shown are sufficient to disclose an illustrative embodiment for practicing the present invention.

As shown in the figure, mobile device 810 includes a processing unit (CPU) 822 in communication with a mass memory 830 via a bus 824. Mobile device 810 also includes a power supply 826, one or more network interfaces 850, an audio interface 852, video interface 859, a display 854, a keypad 856, an illuminator 858, an input/output interface 860, a haptic interface 862, storage medium 866, and an optional global positioning systems (GPS) receiver 864.

Mobile device 810 may optionally communicate with a base station (not shown), or directly with another computing device. Network interface 850 includes circuitry for coupling mobile device 810 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 850 is sometimes known as a transceiver, transceiving device, or network interface card (NIC).

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of mobile device 810 and an operating system 841. Memory 830 further includes one or more data storage 844, which can be utilized by mobile device 810 to store, among other things, applications 842 and/or other data. At least a portion of applications 842 and/or other data may also be stored on storage medium 866, such as a disk drive, removable storage, or the like.

Applications 842 may include computer executable instructions which, when executed by mobile device 810, provide such functions as calendars, contact managers, task managers, transcoders, database programs, word processing programs, screen savers, security applications, spreadsheet programs, games, search programs, and so forth. Applications 842 may further include browser 845 to enable interaction with other computing devices such as server 620, and/or the like.

In certain embodiments, the above discussed advertisement management applications can be used, configured, controlled, and/or the like though a web browser by an advertiser. For example, the web browser can communicate with a web server running server-side advertisement management applications to manage Internet or other online advertising campaigns. However, in other embodiments, an advertiser may use locally installed applications, an ASP or third party may manage an advertising campaign for the advertiser, and/or the like. It is also recognized that the above discussed advertising management applications and elements thereof may be used separately, together, or in any suitable combination.

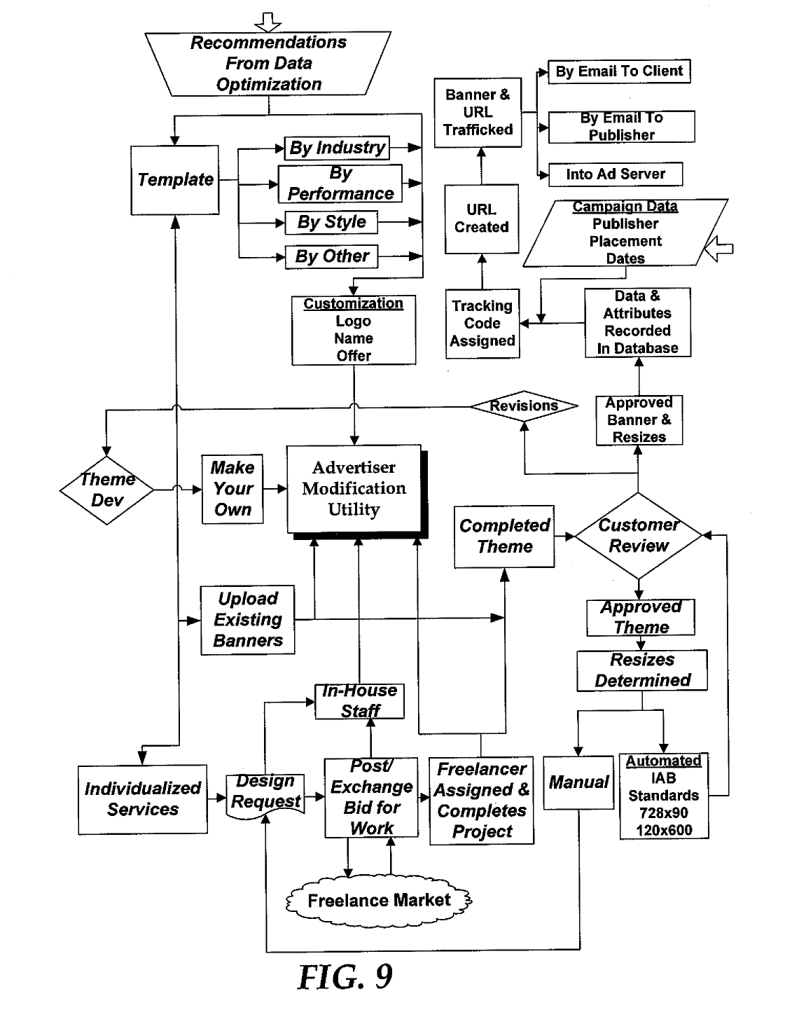

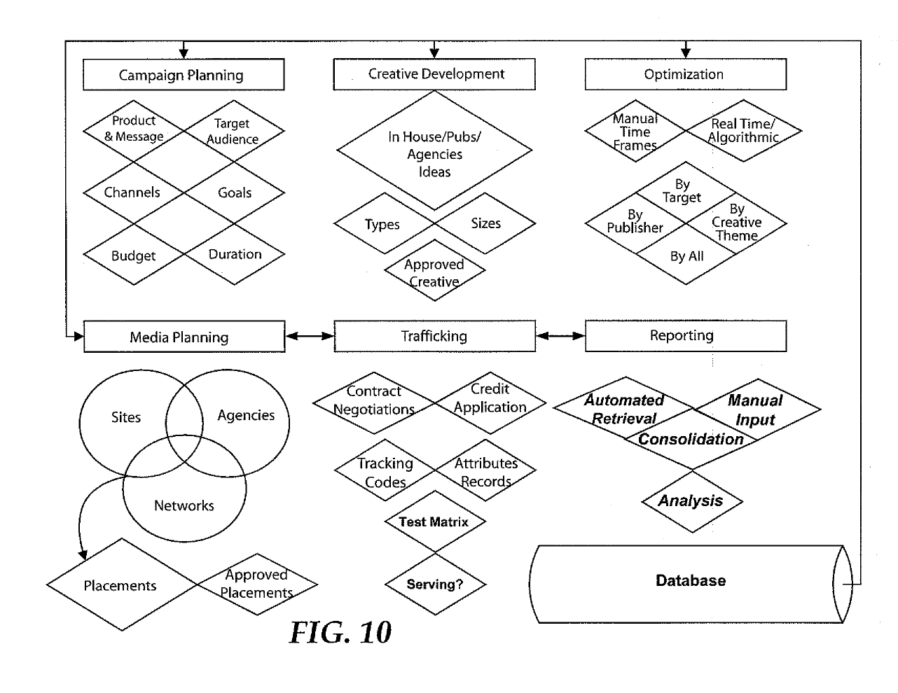

FIGS. 9 and 10 are workflow diagrams depicting two embodiments of advertising workflows. As illustrated, the workflows show possible steps and elements for, creating, generating, customizing and modifying advertisements, advertising campaigns, and elements thereof. It is recognized that certain steps or elements can be omitted or added as suitable for a given implementation. Likewise, the individual steps or elements, and combinations thereof, can be accomplished either manually or automatically, as suitable for each given implementation or as discussed above.

The above specification, examples and data provide a description of the method and applications, and use of the invention. Since many embodiments of the invention can be made without departing from the spirit and scope of the invention, this specification merely set forth some of the many possible embodiments for the invention.

What is claimed as new and desired to be protected by Letters Patent of the United States is:

1. A method of managing modifications to an online advertisement, comprising:
generating the online advertisement from a plurality of different selectable advertisement elements;
publishing the generated online advertisement for access over a network;
collecting metrics for the published online advertisement, wherein the metrics are associated with a performance or effectiveness of the online advertisement;
comparing the collected metrics to metrics associated with another published online advertisement to determine which advertisement elements within the generated online advertisement indicate a highest performance or effectiveness value, and which advertisement elements indicate a lowest performance or effectiveness value; and
modifying the online advertisement based on the comparison to increase an overall performance or effectiveness of the online advertisement.

2. The method of claim 1, wherein modifying the online advertisement further comprises replacing at least one advertisement element within the generated online advertisement having a lowest performance or effectiveness value.

3. The method of claim 1, wherein comparing the collected metrics further comprises:
determining which combinations of advertisement elements provide a highest performance or effectiveness value; and
determining which other combinations of advertisement elements provide a lowest performance or effectiveness value.

4. The method of claim 1, wherein comparing the collected metrics further comprises employing a statistical analysis of combinations of advertisement elements within the published online advertisement and across the other published online advertisement.

5. The method of claim 1, wherein modifying the online advertisement based on the comparison is performed automatically, independent of a user intervention, and wherein modifying the online advertisement further comprises replacing at least one advertisement element with another advertisement element within the generated online advertisement.

6. The method of claim 1, wherein the actions of publishing, collecting metrics, comparing the collected metrics, and modifying the online advertisement based on the comparison are performed iteratively.

7. The method of claim 1, wherein collecting metrics for performance further comprises collecting information associated with at least one of a sale of a product or service associated with the published online advertisement, a completion of a survey, receiving a customer profile, a completion of a customer login, or feedback indicating that a viewer of the online advertisement visited a merchant associated with the online advertisement.

8. A network device for managing modifications to an online advertisement over a network, comprising:
a transceiver to send and receive data over the network; and
a processor that is operative to perform actions, including:
publishing the online advertisement over the network, wherein the online advertisement comprises a plurality of selectable advertisement elements; and
iteratively:
tracking information for the published online advertisement, wherein the tracked information provides at least one of performance metrics or effectiveness metrics;
receiving metrics associated with a plurality of other online advertisements;
analyzing the tracked information with the received metrics to identify at least one selectable advertisement element within the published online advertisement that is associated with at least one of the performance or the effectiveness for the online advertisement; and
modifying the online advertisement by replacing a selectable advertisement element with another selectable advertisement element to increase an overall performance or effectiveness of the online advertisement.

9. The network device of claim 8, wherein analyzing the tracked information further comprises performing statistical analysis tracked information of the online advertisement and the received metrics to determine at least one combination of selectable advertisement elements that increase at least one of the performance or effectiveness, and at least another combination of selectable advertisement elements that decrease at least one of the performance or effectiveness of an online advertisement.

10. The network device of claim 8, wherein modifying the online advertisement further comprises automatically iterating until a performance value or effectiveness value for the modified online advertisement exceeds a defined value.

11. The network device of claim 8, wherein the plurality of selectable advertisement elements further comprises at least one of text, a background color, a foreground color, a size, a font, a font type, a publisher bid, a publisher identity, a page placement, a bitmap, a graphic, an icon, an audio file, a video file, animation, or a targeted demographic.

12. The network device of claim 8, wherein tracking information for the published online advertisement further comprises tracking at least one of a sale of a product or service, a completion of a questionnaire, or a receiving of a customer profile.

13. The network device of claim 12, wherein tracking information for the published online advertisement further comprises tracking at least one of number of click-throughs, a ratio of click-throughs to impressions, a cost per thousand impressions, or a number of viewer interactions.

14. The network device of claim 8, wherein modifying the online advertisement is enabled through an advertisement application, wherein the application provides a user with access to the selectable advertisement elements, and an advertisement library of a plurality of advertisements.

15. A system for use in managing modifications to an online advertisement, comprising:
a library having a plurality of selectable advertisement elements; and
a server configured and arranged to access the library and to further perform actions, comprising:
employing the library to generate the online advertisement using at least some of the plurality of selectable advertisement elements;
publishing the online advertisement for access by viewers over the network;
tracking information for the published online advertisement, wherein the tracked information provides at least one of performance metrics or effectiveness metrics;
analyzing the tracked information with metrics obtained about a plurality of other online advertisements, each of the plurality of other online advertisements comprising at least some selectable advertisement elements, to identify at least one selectable advertisement element within the published online advertisement that is associated with at least one of the performance or the effectiveness for the online advertisement; and
modifying the online advertisement by replacing a selectable advertisement element with another selectable advertisement element to increase an overall performance or effectiveness of the online advertisement.

16. The system of claim 15, wherein at least one selectable advertisement element comprises at least one of a coupon or a promotion.

17. The system of claim 15, wherein analyzing the tracked information with metrics further comprises determining at least one combination of selectable advertisement elements that increase at least one of the performance or effectiveness of an advertisement.

18. The system of claim 15, wherein tracking information for the published online advertisement further comprises tracking at least one of a sale of a product or service associated with the published online advertisement, a completion of a survey, receiving of a customer profile, a completion of a customer login, or feedback indicating that a viewer of the online advertisement visited a merchant associated with the online advertisement.

19. The system of claim 15, wherein the server is configured and arranged to a further perform actions, comprising: automatically iterating on at least the publishing, tracking, analyzing, and modifying actions until a performance value or effectiveness value for the modified online advertisement exceeds a defined value.

20. The system of claim 15, wherein tracking information further comprises tracking information associated with at least one of a sale associated with the published online advertisement, a completion of a form by a viewer, or feedback indicating that a viewer of the online advertisement visited a merchant associated with the online advertisement.
